(19) United States
(12) Patent Application Publication
(10) Pub. No.: US 2008/0107283 A1
(43) Pub. Date: May 8, 2008

(54) Audio/video portable electronic devices providing wireless audio communication and speech and/or voice recognition command operation

(76) Inventor: Lance Fried, Del Mar, CA (US)

Correspondence Address: STETINA BRUNDA GARRED & BRUCKER, 75 ENTERPRISE, SUITE 250, ALISO VIEJO, CA, 92656, US

(21) Appl. No.: 12/006,513

(22) Filed: Jan. 3, 2008

Related U.S. Application Data
(63) Continuation of application No. 11/247,651, filed on Oct. 11, 2005.
(60) Provisional application No. 60/621,336, filed on Oct. 22, 2004.

(51) Int. Cl. H04B 3/00

(52) U.S. Cl. 381/77

(57) ABSTRACT

An improved audio/video system is provided that facilitates increased ease of use. An audio/video device can be provided with a first antenna, with wireless signals emitted by the first antenna comprising signals created from audio content provided by the device. A headset can be provided with an antenna for receiving the wireless signals. A microphone in communication with the audio/video device can be provided for receiving speech commands issued by a user of the audio/video device, with the device being configured to respond to the speech commands. The device can optionally be configured to recognize the voice of one or more particular users. As a result of the wireless transmission of signals between the audio/video device and the headset, and/or the use of speech/voice recognition commands, the device can be conveniently operated by the user. One or more components of the system can also be configured to be waterproof.

### CROSS-REFERENCE TO RELATED APPLICATIONS

This application claims the benefits of U.S. Provisional Application No. 60/621,336, filed Oct. 22, 2004, the entire contents of which are incorporated herein by reference.

### STATEMENT RE: FEDERALLY SPONSORED RESEARCH/DEVELOPMENT

Not Applicable

### BACKGROUND

The present invention relates generally to audio/video/electronic devices.

With the proliferation of various audio and video formats in recent years, consumers are increasingly relying on the use of portable devices capable of playing back music (such as mp3 files) and/or video (such as mp4 files). Because of the portable nature of such devices, they can allow users to enjoy music and/or videos at convenient locations.

Despite the portability offered by such devices, the operation of such devices is not always convenient. One drawback of certain such devices is the necessity for a user's headset to be connected to the device. Typically, in order for a user to listen to music or the audio portions of videos from such a device, the user must wear a headset that is physically connected to the device.

Such a configuration is not always ideal. For example, if a user is engaged in sporting activities, the physical connection of the headset to the device may limit the user's mobility. Moreover, the possible jostling of the headset during such activities may cause earpieces of the headset to be dislodged from the user's ears, or cause the headset to become disconnected from the device. In either case, the user may experience an undesirable interruption.

Another drawback of certain such devices is the necessity for a user to physically manipulate buttons and/or other controls on the device in order to control the playback of music or videos from the device. Unfortunately, the need to manipulate such physical controls can require the user to keep the device in relatively close proximity to the user in order to effectively operate the device.

In view of the above-identified limitations, there exists a need for a more user-friendly and hands-free approach to the implementation and usage of audio/video devices. Such an approach would preferably provide for wireless communications between a user's headset and an audio/video device. In addition, it would further be preferable for a user to be able to operate an audio/video device through speech recognition commands and/or voice recognition features.

### BRIEF SUMMARY

The present invention roughly described, provides an improved audio/video system that facilitates increased ease of use by users of the system. In certain embodiments, the system provides flexibility in where an audio/video device can be placed on and/or relative to a user's body through the elimination of a physical connection between a headset worn by the user and the device. In other embodiments, the system provides further flexibility through the implementation of speech recognition and/or voice recognition features. In one embodiment, the system comprises an audio/video device for providing audio content to a user. A first antenna in communication with the device can be provided for emitting wireless signals from the device. Such wireless signals can comprise signals created from the audio content provided by the audio/video device. A headset can also be provided with an antenna for receiving the wireless signals. As a result of the wireless transmission of signals between the audio/video device and the headset, the audio/video device can be conveniently operated by a user without requiring a physical connection between the headset and the audio/video device.

In another embodiment, an audio/video device can be provided with a microphone for receiving speech commands from a user, with the audio/video device being configured to respond to the speech commands. The audio/video device can further be configured to provide voice recognition features, causing the device to respond only to speech commands issued by a particular user or users, and ignore commands issued from other users and/or other sources. As a result of the speech command operation and/or voice recognition features, the audio/video device can be conveniently operated by a user without requiring the user to physically manipulate controls of the device.

In various embodiments, one or more components of the audio/video system can be configured to be waterproof. These as well as other embodiments contemplated by the present invention will be more fully set forth in the detailed description below and the figures submitted herewith.

### BRIEF DESCRIPTION OF THE DRAWINGS

FIG. 1 illustrates a system for providing wireless communication between an audio/video device and a user's headset in accordance with an embodiment of the present invention;

FIG. 2 illustrates a system for providing speech command operation of an audio/video device in accordance with an embodiment of the present invention;

FIG. 3 illustrates a system for providing wireless communication between an audio/video device and a user's headset, as well as speech command operation of the audio/video device in accordance with an embodiment of the present invention; and

FIG. 4 illustrates a user with the audio/video device mounted to the user's arm and audio/video device wirelessly communicating with the headset worn by the user.

### DETAILED DESCRIPTION

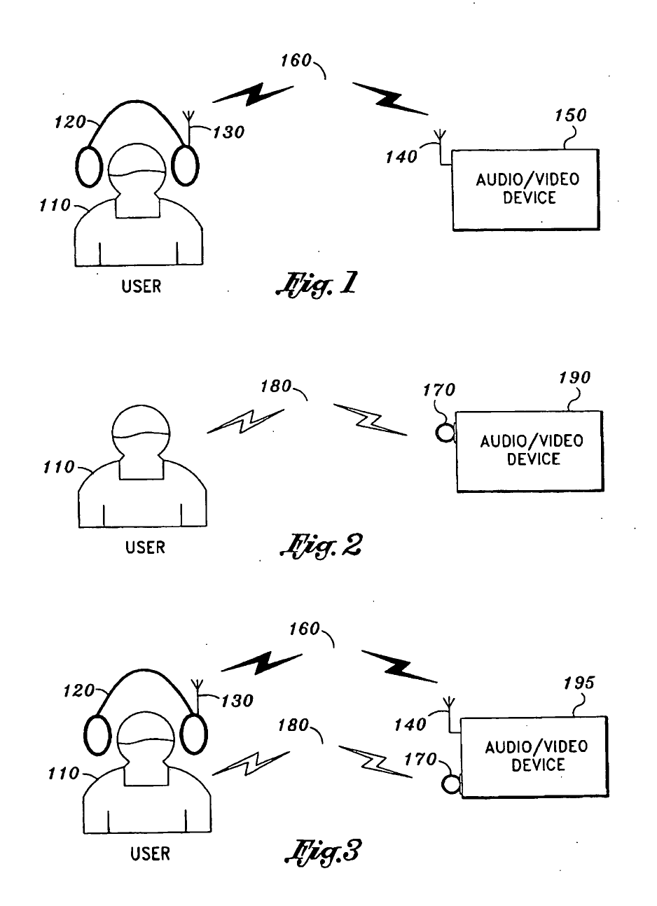

FIG. 1 illustrates a system for providing wireless communication between an audio/video device 150 and a user's headset 120 in accordance with an embodiment of the present invention. It will be appreciated that audio/video device 150 (as well as devices 190 and 195 further described herein) can be any device providing features for playing or otherwise providing audio content (for example, music, audio recordings, live audio transmissions, the audio portions of a video and/or video content, and/or any other audio content) and/or video content (for example, videos, pictures, and/or any other video content) to a user 110. Examples of such devices include, but need not be limited to: mp3 players, mp4 players, CD players, DVD players, radios, and/or any other suitable device for playing audio and/or video content, whether such content is stored in, read from, and/or received from one or more memories, files, digital data formats, analog data formats, tracks, wires, wireless signals, and/or other media or formats. Accordingly, it will be appreciated that audio/video devices contemplated by the present invention need not provide both audio and video content to a user 110. In a preferred embodiment, audio/video device 150 (as well as devices 190 and 195 further described herein) can be a portable device, however non-portable devices are also contemplated by the present disclosure.

An audio/video device 150 in accordance with the embodiment of FIG. 1 can be implemented with an antenna 140 for transmitting audio content to a user 110 through wireless signals 160 emitted from the antenna 140. Device 150 can include appropriate hardware and/or software for converting digital and/or analog signals extracted from audio content provided by the device 150 into wireless signals 160. It will be appreciated that wireless signals 160 can be implemented in accordance with Bluetooth™ technology, FM frequency signals, and/or any other appropriate signal formats. It will further be appreciated that antenna 140 and antenna 130 (further described herein) can be implemented as any type of antenna capable of transmitting and/or receiving wireless signals 160.

As provided in FIG. 1, a user 110 of the audio/video device 150 can wear a headset 120 for listening to audio content provided by the device 150. It will be appreciated that headset 120 can be implemented in accordance with any appropriate headset style, such as closed ear headphones, earphones inserted into the user's ear, and/or other styles. It is further contemplated that headset 120 can be implemented as one or more devices that provide for the transmission of sound waves through bone and/or cartilage, and do not require placement in and/or near a user's ear. In various embodiments, headset 120 can also be implemented as a waterproof headset, as shown in FIG. 4.

As illustrated, headset 120 can be provided with an antenna 130 for receiving wireless signals 160 from the antenna 140 of the device 150. Appropriate hardware and/or software can be provided in headset 120 for converting the wireless signals 160 into sound waves that are passed to the user 110, thereby permitting the user 110 to listen to audio content provided by the device 150 without requiring the headset 120 to be physically connected to the device 150.

FIG. 2 illustrates a system for providing speech command operation of an audio/video device 190 in accordance with an embodiment of the present invention.

An audio/video device 190 in accordance with the embodiment of FIG. 2 can be implemented with a microphone 170 for receiving speech commands 180 provided by a user 110 of the device 190. Device 190 can include appropriate hardware and/or software for recognizing the speech commands 180 received by the microphone 170, and taking action in response to such commands.

It will be appreciated that device 190 can be configured to recognize any desired combination of speech commands for controlling the operation of the device 190. For example, in one embodiment, device 190 can be configured to recognize speech commands for “next song,” “stop,” etc. However, it will be appreciated that any of the controls that may be desirable to be implemented on device 190 can similarly be controlled by appropriate speech commands issued by user 110. Such commands can include, but need not be limited to: “on,” “off,” “play,” “stop,” “pause,” “next song,” “previous song,” “fast forward,” “rewind,” “increase volume,” “decrease volume,” and/or other appropriate commands.

The hardware and/or software of device 190 can be further configured to recognize only the voice of a particular user 110 or users, thereby providing voice recognition command operation. In such an embodiment, the device 190 can be made to respond to speech commands issued by the user 110, and to ignore speech commands issued by other persons.

In order to facilitate the user's 110 listening to audio content from the device 190, the user 110 may utilize a wired and/or wireless headset (not shown in FIG. 2) in communication with the device 190. In various embodiments, microphone 170 can be implemented as part of the headset, thereby permitting speech commands to be communicated from the headset to the device 190 through an appropriate wired and/or wireless connection.

As a result, a user 110 of device 190 can simultaneously listen to audio content provided by the device 190 through a headset (not shown in FIG. 2) and operate the device 190 through speech commands.

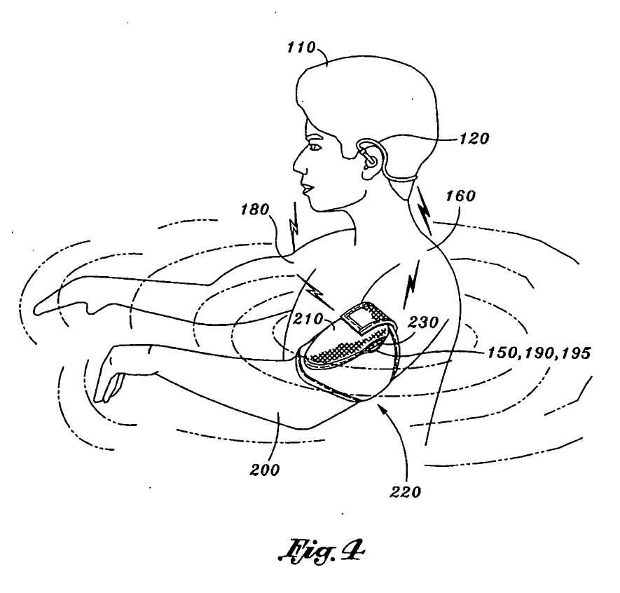

FIG. 3 illustrates a system for providing wireless communication between an audio/video device 195 and a user's headset 120, as well as speech command operation of the audio/video device 195 in accordance with an embodiment of the present invention.

The audio/video device 195 of FIG. 3 can be configured to implement the functionality provided by audio/video devices 150 and 190 of FIGS. 1 and 2, respectively.

As discussed above in relation to FIG. 1, device 195 can be implemented with an antenna 140 for transmitting audio content to the user 110 through wireless signals 160 emitted from the antenna 140. Device 195 can include appropriate hardware and/or software for converting digital and/or analog signals extracted from audio content provided by the device 195 into wireless signals 160.

As also discussed above in relation to FIG. 1, a user 110 of the audio/video device 195 can wear a headset 120 for listening to audio content provided by the device 195. Headset 120 can also be provided with an antenna 130 for receiving wireless signals 160 from the device 195. Appropriate hardware and/or software can further be provided in headset 120 for converting the wireless signals 160 into sound waves that are passed to the user 110, thereby permitting the user 110 to listen to audio content provided by the device 195 without requiring the headset 120 to be physically connected to the device 195.

As discussed in relation to FIG. 2, device 195 can also be implemented with a microphone 170 for receiving speech commands 180 provided by the user 110 of the device 195. In various embodiments, microphone 170 can be implemented as part of the headset 120, thereby permitting speech commands to be communicated from the headset 120 to the device 195 through an appropriate wired and/or wireless connection.

Device 195 can further include appropriate hardware and/or software for recognizing the speech commands 180 received by the microphone 170, and taking action in response to such commands. Device 195 can be configured to recognize any desired combination of speech commands for controlling the operation of the device 195 as previously described in relation to FIG. 2. As also previously described in relation to FIG. 2, device 195 can be further configured to recognize only the voice of a particular user 110 or users, thereby providing voice recognition command operation.

It is contemplated that any of the various components of the systems described herein can be configured to be waterproof, thereby further increasing the flexibility and ease of use of such components by users. For example, if headset 120 is implemented as a waterproof headset, and wireless signals 160 are implemented as FM frequency signals, it is contemplated that a user 110 may listen to audio and/or video played from a device 150 and/or 195 while underwater.

Referring now to FIG. 4, a user 110 is shown wearing a waterproof audio/video device 150, 190, or 195 on the user's arm 200. The waterproof audio/video device 150, 190, 195 may be inserted into a pouch 210 of an armband 220 and the armband 220 is wrapped around and secured to the user's arm 200. If the waterproof audio/video device 190 or 195 is inserted into the pouch 210, then the waterproof audio/video device 190, 195 may be operative to receive speech commands 180 via a microphone 170 attached to the waterproof audio/video device 190, 195, as shown in FIG. 4. Alternatively, the user may speak speech commands 180 which are received by a microphone 170 attached to the headset 120. In a further alternative embodiment, it is contemplated that the waterproof audio/video device 150, 190, 195 may be operated via control buttons 230. The waterproof audio/video device 150, 190, 195 and/or the headset 120 may be waterproof such that the user 110 may listen to his/her favorite music while swimming or engaging in other water related sports (e.g., snowboarding, skiing, etc.).

It will be appreciated that the scope of the present invention is not limited by the particular embodiments set forth herein. Other appropriate variations, whether explicitly provided for or implied, are contemplated by the present disclosure. The ordering of various steps described herein can be changed where appropriate to achieve the functionality provided by the present invention. Individual steps and/or components can be combined and/or dissected into fewer or greater numbers of steps and/or components where appropriate to provide the functionality described herein.

1. A system for providing wireless transmission of audio content to a user, the system comprising:
a wearable waterproof audio device for providing audio content to the user;
a first antenna attached to the audio device and in communication with the device for emitting wireless signals from the device, the wireless signals comprising signals created from the audio content;
a wearable waterproof headset; and
a second antenna attached to the headset and in communication with the headset for receiving the wireless signals.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. The system of claim 1 wherein the audio device is an audio/video device, mp3 player, mp4 player, CD player, DVD player, entertainment device or radio.

23. The system of claim 1 wherein the wearable waterproof audio device is attachable to the user's body such that while the user is participating in a physical activity the wearable waterproof device does not significantly impede the user's mobility.

24. A system for authenticating a specific user and operating an audio entertainment device, the system comprising:
the audio entertainment device having a microprocessor for providing audio content to an audio output device, the microprocessor having a program for performing the following steps;
providing a plurality of speech commands;
training the audio entertainment device to recognize only spoken speech commands of the specific user;
actuating the audio entertainment device in accordance with a spoken speech command only upon recognition that the spoken speech command is the specific user;
ignoring spoken speech commands when the spoken speech command is not recognized as the specific user; and
a microphone in communication with the audio entertainment device for receiving spoken speech commands which are transmitted to the microprocessor of the audio entertainment device.

25. The system of claim 24 wherein the program further includes the steps of:
actuating the audio device in accordance with the spoken speech command upon recognition of the spoken speech command regardless of the user;
switching between the steps of actuating the audio device in accordance with a spoken speech command only upon recognition of the user via the spoken speech command and ignoring spoken speech commands when the user is not recognized via the spoken speech command and the step of actuating the audio device in accordance with the spoken speech command upon recognition of the spoken speech command.

26. The system of claim 24 wherein the audio device is waterproof.

27. The system of claim 24 further comprising:
a first antenna in communication with the device for emitting wireless signals from the device, the wireless signals comprising signals created from the audio content;
a waterproof headset; and
a second antenna in communication with the waterproof headset for receiving the wireless signals.

28. The system of claim 24 wherein the program steps both authenticates the specific user and operates the audio entertainment device via the spoken speech command.

29. A wearable system for providing wireless transmission of audio content to a user while the user is participating in a physical activity without significantly impeding the user's mobility, the system consisting essentially of:
a wearable waterproof audio device for providing audio content to a user;
a first antenna attached to the audio device and in communication with the device for emitting wireless signals from the device, the wireless signals comprising signals created from the audio content;
a microprocessor disposed within the waterproof audio device for providing audio content to the user, the microprocessor having a program for performing the following steps;
loading a plurality of speech commands;
training the device to recognize only spoken speech commands of the user;
recognizing the speaker of the spoken speech command to be the user;
after the recognizing step, actuating the audio device in accordance with the spoken speech command;
ignoring spoken speech commands when the speaker of the spoken speech command is not the user;
a wearable waterproof headset; and
a second antenna attached to the headset and in communication with the headset for receiving the wireless signals.

30. The wearable system of claim 29 wherein the program further includes the steps of:
recognizing the spoken speech command regardless of the speaker; and
switching between the steps of recognizing the speaker of the spoken speech command to be the user, after the recognizing step, actuating the audio device in accordance with the spoken speech command, and ignoring spoken speech commands when the speaker of the spoken speech command is not the user and the step of recognizing the spoken speech command regardless of the speaker.
